(19) United States
(12) Patent Application Publication
(10) Pub. No.: US 2010/0083812 A1
(43) Pub. Date: Apr. 8, 2010

(54) Acoustic Drum With Resonators Disposed Therein

(75) Inventor: Hartley D. Peavey, Meridian, MS (US)

Correspondence Address: GIBSON & DERNIER LLP, 900 ROUTE 9 NORTH, SUITE 504, WOODBRIDGE, NJ, 07095, US

(73) Assignee: PEAVEY ELECTRONICS CORPORATION, Meridian, MS (US)

(21) Appl. No.: 12/244,171

(22) Filed: Oct. 2, 2008

(51) Int. Cl. G10D 13/02

(52) U.S. Cl. 84/411 R

(57) ABSTRACT

An acoustic drum includes: a shell having first and second, spaced apart ends, and an interior surface defining an interior volume; a drumhead stretched over the first end of the shell; and at least one resonator coupled at one edge in lever fashion to the interior surface of the shell, the at least one resonator being sized and shaped to resonate at a frequency proximate to a peak resonant frequency of the drum.

### BACKGROUND OF THE INVENTION

The present invention relates to an acoustic drum having a resonator therein, which is operable to improve the resonant characteristics of the drum.

Essentially, a drum is the simplest musical instrument, comprising an enclosure or shell of some kind, and a membrane (or head) stretched over an opening of the shell. The operational principle of drums are fairly simple, they are resonant systems, essentially Helmholtz resonators. Energy is imparted to the head by striking it with some type of object, such as a stick, mallet or a player's hand. The energy imparted to the head activates air inside the shell of the drum, thereby creating a resonant effect, which is recognizable as what is generally referred to as a drum beat.

Modern drums emerged in the late 1800s, and included a shell and one or two heads that were secured to the drum shell by a wooden or metal rim (or hoop) that served to fasten and tension the head to the shell. Machine screws extended through the rim into a series of metal fixtures (called lugs) that were attached around a periphery of the shell. In order to create a secure mounting structure for the lugs, the shell itself must be fairly thick to provide enough strength to withstand the pull of the rim as the head was tensioned over the end of the shell.

The mass of the relatively thick shell and the mass of the metal lugs tended to significantly dampen the resonance of the drum system. Conventional drums today are of very similar construction and operation as the drums of the 1800s (and even those of thousands of years ago) and, therefore, suffer significant impairment of their resonant capabilities—again, due to the relatively thick shell construction and the multiple lugs holding the head and hoop of the drum.

Recognizing the inherent limitations of conventional drum design, Peavey Electronics Corporation filed for and obtained U.S. Pat. No. 5,353,674, which discloses a novel approach with respect to the then-existing technology, which utilizes an extremely thin drum shell (approx 0.90 inches thick) so as to promote resonance. In addition, the drum employs no lugs and the drum head is clamped to a radial bridge to achieve structural rigidity without damping the resonance of the shell. The drum produces superior resonance, tonality, and output level versus the conventional drums of the time. The entire disclosure of U.S. Pat. No. 5,353,674 is incorporated by reference herein.

It is nevertheless desirable to further improve the resonance of an acoustic drum.

### SUMMARY OF THE INVENTION

Among the objects of the present invention is to enhance the resonance characteristics of drums.

One of the approaches to implementing the present invention is to provide apparatus inside the drum (within the interior volume of the shell) to enhance the resonant characteristics thereof.

As a drum is a resonant system, it has a specific resonant frequency at which the component(s) of the system (e.g., the shell, the heads, and whatever attachment means is utilized) resonates at the highest magnitude. In addition to the resonant frequency (at which the highest magnitude resonance occurs), the drum includes a specific range of frequencies that comprise the resonant curve (or resonant peak curve), which is usually a bell-shaped curve. The resonant peak curve results from several contributing factors, such as the internal volume of the drum, the mass of the structure of the drum, the mass and tightness of the head (or heads), etc. Thus, the particular diameters, lengths, and construction characteristics of different drums determine where each of the resonant peaks of the drums are located and shaped in the audio frequency spectrum.

In accordance with one or more aspects of the present invention, internal resonant members of the proper size, mass, and configuration are disposed within the internal volume of the shell of the drum to enhance the frequency range at the peak resonance of the drum. More specifically, the internal resonant members increase the magnitude(s) of the resonance(s) at and/or around the top of the bell-shaped curve. The internal resonant members (which may be called augmenters or vanes) may have the same general resonance as the drum itself.

When the head of the drum is struck, the drum tends to resonate at its fundamental resonant frequency. Until now, the only thing resonating inside the drum has been the air column, which is established by the head at one or both ends. The internal resonant structures (augmenters) inside the drum are sized, shaped, and positioned within the drum such that they are activated by the acoustic energy imparted by the drum head being struck (as is the air column inside the drum), and such that the internal resonant structures resonate at the desired peak resonant frequency of the drum. The internal augmenters both resonate and enhance the resonant peak of the drum. Since the internal augmenters are significantly more massive than air, the resonance will be both longer and stronger than with the internal air column alone.

In accordance with one or more embodiments of the present invention an acoustic drum includes: a shell having first and second, spaced apart ends, and an interior surface defining an interior volume; a drumhead stretched over the first end of the shell; and a plurality of resonators, each coupled at one edge thereof in lever fashion to the interior surface of the shell, and each resonator being sized and shaped to resonate at a frequency proximate to a peak resonant frequency of the drum. In alternative embodiments, there may be a single such resonator.

Each of the resonators may be substantially planar. Additionally or alternatively, each of the resonators may include a surface area of sufficient magnitude to: (i) receive acoustic energy from the drumhead, when struck; and (ii) move a sufficient amount of air within, and increase a magnitude of the acoustic energy within, the shell at the peak resonant frequency and/or another frequency on the resonant curve.

The resonators are preferably disposed in co-planar relationship to one another. The interior surface of the shell defines a substantially circular cross section; and the resonators are disposed radially about a circumference of the interior surface of the shell. Preferably, the resonators are circumferentially spaced apart from one another to permit air to flow therebetween.

In one or more embodiments, each of the resonators includes an opposite edge to the one edge thereof; and the opposite edge of each resonator is concave curvilinear. The concave curvilinear opposite edges of the resonators may define a central aperture through which an acoustic air column may pass. In this way, the resonators minimize interference with the passage of the sound pressure wave of the acoustic air column from one end of the shell to the other end. For example, the cross-sectional area of the interior volume at which the resonators are located may define an acoustic air flow passage area. In one example, a total amount of the acoustic air flow passage area interrupted by the resonators may be no more than about 40%-50% thereof. This particular percentage (ratio) may minimize interference with the passage of the sound pressure wave of the acoustic air column from one end of the shell to the other end. It should be appreciated, however, that other percentages are contemplated.

The resonators are substantially planar and include first and second opposing surfaces. In one or more embodiments, the first and second surfaces are preferably substantially parallel with the drumhead. In other embodiments, the first and second surfaces may be transversely oriented with respect to the drumhead. In one example, the resonators may be located approximately half-way between the first and second ends of the shell. Other locations within the shell are also contemplated.

The drum may include a connecting means operable to rigidly couple the one edge of a resonator to the interior surface of the shell. Preferably no more than about 20% of the length of the edge is rigidly coupled to the shell. This may prevent damping of the resonator and improve the resonance thereof. It should be appreciated, however, that other percentages are contemplated. Preferably the one edge of the resonator is spaced away from the interior surface of the shell. The spacing between the interior surface of the shell and the one edge of the resonator may be about 10% of the length of the edge. Again, other percentages are contemplated.

Other aspects, features, and advantages of the present invention will be apparent to one skilled in the art from the description herein taken in conjunction with the accompanying drawings.

### DESCRIPTION OF THE DRAWINGS

For the purposes of illustration, there are forms shown in the drawings that are presently preferred, it being understood, however, that the invention is not limited to the precise arrangements and instrumentalities shown.

FIG. 1 is a perspective view of a drum having resonator structures located therein in accordance with one or more aspects of the present invention;

FIG. 2A is a top view of the drum of FIG. 1;

FIG. 2B is a top view of an alternative configuration of the drum of FIG. 2A;

FIG. 3 is a perspective view of a drum head and hardware that may be used in conjunction with the drum of FIG. 1, and/or other embodiments herein;

FIG. 4 is an example of a peak resonance curve of the drum of FIG. 1;

FIG. 5 is a perspective view of a drum having resonator structures of an alternative configuration in accordance with one or more aspects of the present invention;

FIG. 6 is a top view of the drum of FIG. 5;

FIG. 7 is a perspective view of a drum having resonator structures of a further alternative configuration in accordance with one or more aspects of the present invention;

FIG. 8 is a top view of the drum of FIG. 7.

### DETAILED DESCRIPTION OF THE PREFERRED EMBODIMENTS

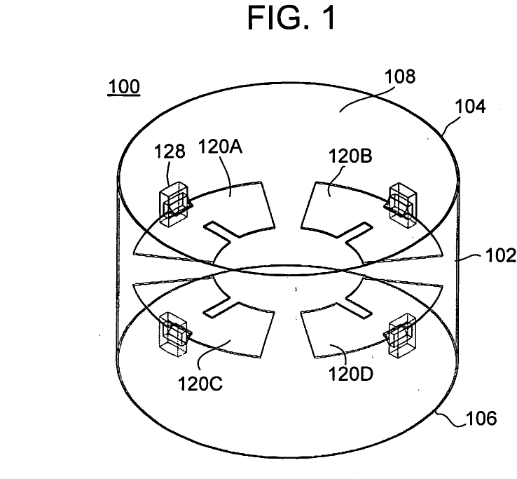

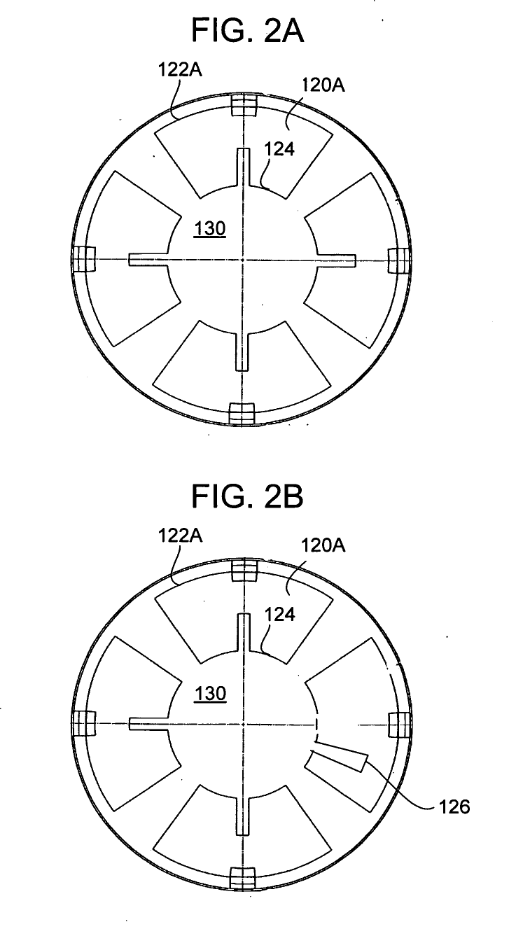

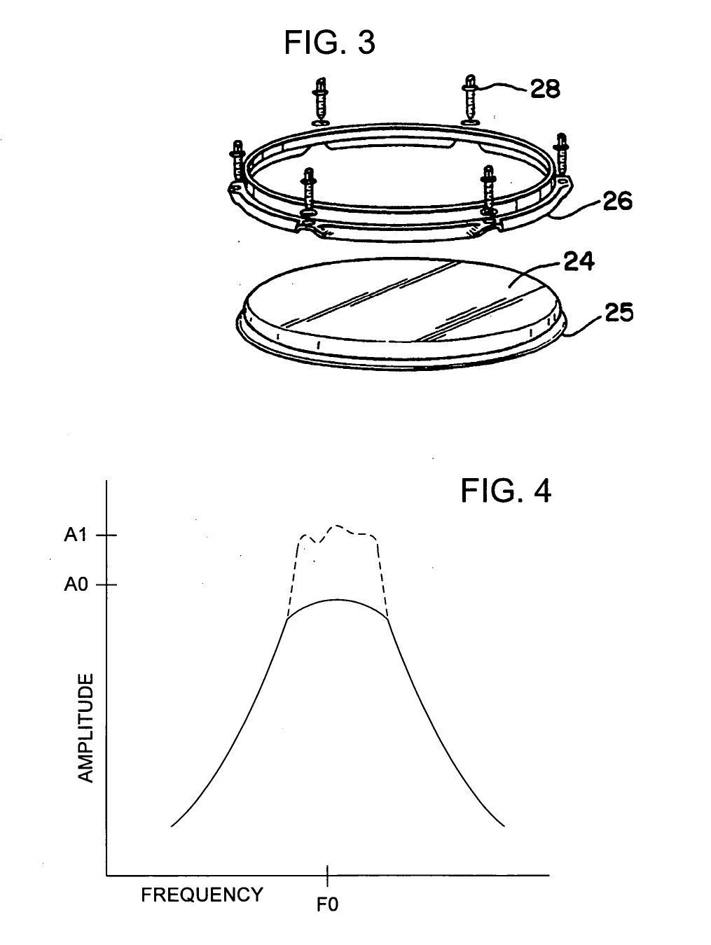

With reference to the drawings, wherein like numerals indicate like elements, there is shown in FIGS. 1-2A a drum 100. The drum 100 includes a shell 102 having first and second, spaced apart ends 104, 106, and an interior surface 108 defining an interior volume 110. As best seen in FIG. 3, a drumhead 24 may be stretched over the first end 104 of the shell 102 and secured using a rim 26 and bolts 28. The rim engages a bead 25 of the drumhead 24 in order to even stretch the drumhead 24 over the first end 104 of the shell 102. Although not required, a second drumhead (not shown) of the same or similar construction as the drumhead 24 may be employed and stretched over the second end 106 of the shell 102.

One or more resonators 120A, 120B, 120C, 120D, are coupled to the inside surface 108 of the shell 102. In particular each resonator 120 is coupled at one edge (for example, edge 122A) thereof in lever fashion to the interior surface 108 of the shell 102. The drum 100 may include a connecting means 128 to rigidly couple the one edge 122 of the resonator 120 to the interior surface 108 of the shell 102. The connecting means may include small wooden blocks with the resonator 120 being slid, clamped, glued, or otherwise fastened to the block. Preferably no more than about 20% of the length of the edge is rigidly coupled to the shell. Preferably the one edge of the resonator is spaced away from the interior surface of the shell. The spacing between the interior surface of the shell and the one edge of the resonator may be about 10% of the length of the edge.

Each resonator is sized and shaped to resonate at a frequency proximate to the peak resonant frequency of the drum 100. Each of the resonators 120 may be substantially planar and include a surface area of sufficient magnitude to receive acoustic energy from the drumhead 24, when struck, and/or the shell 102 and resonate at the peak resonant frequency of the drum 100. The resonators 120 may be formed from a relatively thin material having predictable and stable resonant characteristics, such as metal, plastic, fiber, and/or wood materials.

As best seen in FIG. 4, the peak resonance curve of the drum 100 is bell-shaped, having a peak amplitude, A, at resonance frequency, F0. Without the resonators 120, the amplitude of the resonance at frequency F0 of the drum 100 is at A0. With the resonators 120, however, the amplitude of the resonance at frequency F0 of the drum 100 is at A1, a significantly higher level. Indeed, the resonators 120 are sized and shaped to have sufficient surface area to resonate at the peak resonant frequency of the drum 100, while moving a sufficient amount of air within the drum 100 to increase the amplitude of the resonance at the peak resonant frequency F0.

The resonators 120 essentially operate like a tuning fork in that they resonate over a fairly narrow range of frequencies when activated. But unlike a tuning fork, the resonators 120 have significant surface area so as to receive energy from the vibrating drumhead 24 (both as a sound pressure wave off the back side of drumhead 24 and additionally from the resonant shell 102 of the drum 100 itself). The resonance of the resonators 120 increase the total resonance of the drum 100 and maximize the loudness of the drum 100 by augmenting the resonance of the air column inside the drum 100.

The resonators 120 are preferably disposed in co-planar relationship to one another. The interior surface 108 of the shell 102 defines a substantially circular cross section, and the resonators 120 are disposed radially about the circumference of the interior surface 108. The resonators 120 are substantially planar and include first and second opposing surfaces, which are preferably substantially parallel with the drumhead 24. In other embodiments, the first and second surfaces may be transversely oriented with respect to the drumhead 24. The resonators 120 may be located approximately half-way between the first and second ends 104, 106 of the shell 102. This particular location of the resonators 120 within the shell 102 may be desired for some drums 100, although it will be appreciated that other locations are contemplated if better performance characteristics would result.

It is desirable to size and shape the resonators 120 to minimize interference with the passage of the sound pressure wave of the acoustic air column from one end 104 of the shell 102 to the other end 106, while also maintaining sufficient surface area of each resonator 120 to move a substantial amount of air. In order to minimize the interference with the passage of the sound pressure wave, and maintain individual resonance characteristics of each resonator 120, the resonators 120 are circumferentially spaced apart from one another to permit air to flow therebetween. The configuration of the resonators illustrated in this and other embodiments herein are somewhat similar to the petals of a flower, but are attached at multiple points to the interior surface 108 of the shell 102.

In the example implementation shown, each of the resonators 120 includes an opposite edge 124 to the edge 122 coupled to the shell 102. The opposite edge 124 of each resonator 120 is concave curvilinear. The concave curvilinear edges 124 of the resonators 120 may define a central aperture 130 through which the acoustic air column may pass uninterrupted. For example, the cross-sectional area of the interior volume 110 at which the resonators 120 are located may define an acoustic air flow passage area. In the example shown, a total amount of the acoustic air flow passage area interrupted by the resonators may be no more than about 40%-50% thereof. This particular coverage may minimize interference with the passage of the sound pressure wave of the acoustic air column from one end of the shell 102 to the other end. It should be appreciated, however, that other percentages are contemplated.

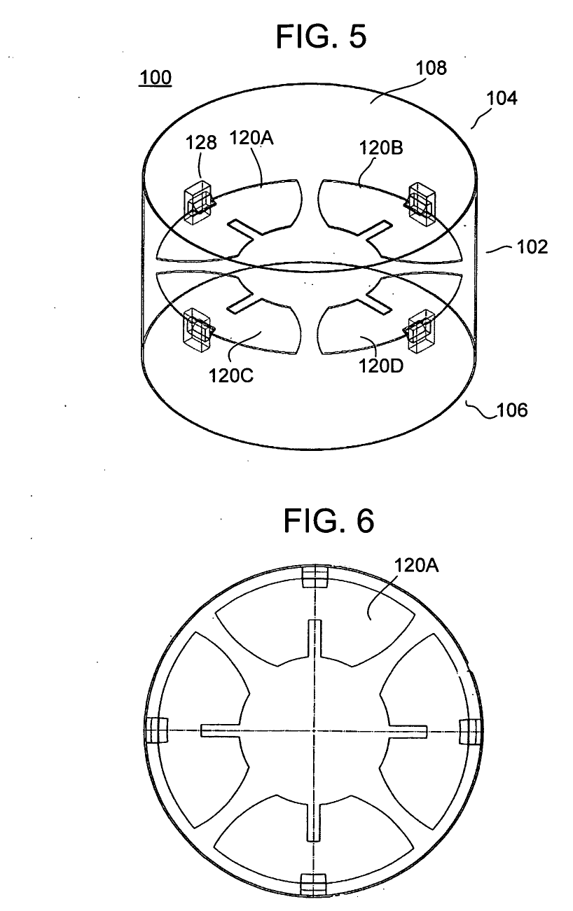

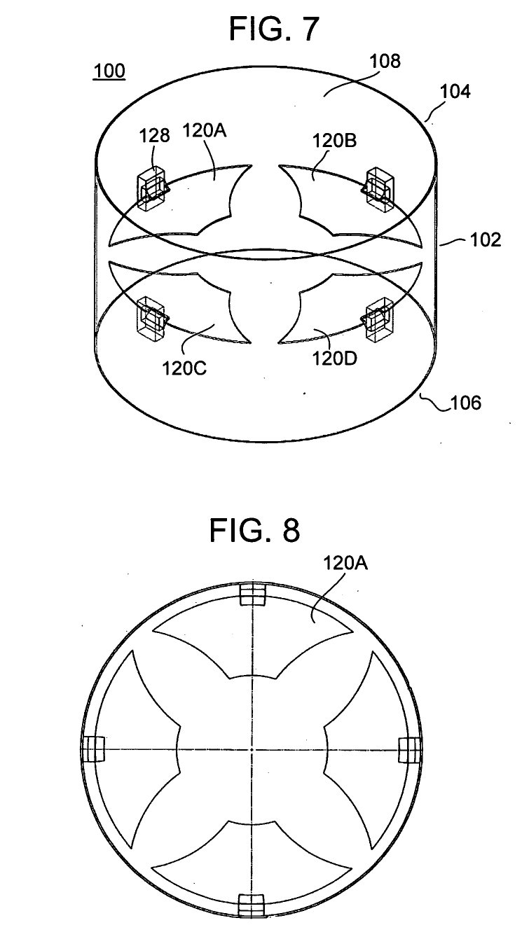

The particular size and shape of the resonators 120 may vary as illustrated in FIGS. 5-8. The resonance characteristics of the resonators 120 are a function of the dimensions, the density, and the elastic modulus of the material(s) from which they are manufactured. The resonance frequency, f, may be computed according to the following equation:

$$f = k \sqrt{\frac{E}{ρ}}$$

where the physical dimensions of the resonator 120 are represented by k, the elastic modulus of the resonator is represented by E, and the density ρ.

Those skilled in the art will appreciate that the exact frequency F0 of the drum 100 may not be predicted with certainty; indeed, a number of factors contribute to differences in the frequency F0 from drum-to-drum, such as altitude, pressure, physical characteristics of the drum 100, etc. Thus, in one or more embodiments, one or more of the resonators 120 may be designed to resonate over a range of frequencies, such as FO±10 to 20 Hz. Thus, the one or more resonators 120 may accommodate and respond to the varying factors above and still improve the overall resonance characteristics of the drum 100. In order to achieve such functionality, as best seen in FIG. 2B, one or more of the resonators 120 may include an offset (and/or elongated) slot 126, which operates to skew the frequency of resonance of the resonator 120, such as by about ±10 to 20 Hz. Although this modification to the slot 126 (as compared to the other slots of the drum 100) may reduce the efficiency of the resonance at FO, the shift of resonance by about ±10 to 20 Hz may assist in compensating for differences in the frequency F0 from drum-to-drum.

In accordance with one or more embodiments of the present invention, one or more of the mechanisms, features, aspects, etc. of the drum systems illustrated in U.S. Pat. No. 5,353,674 are employed in the drum 100 of the present invention.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An acoustic drum, comprising:
a shell having first and second, spaced apart ends, and an interior surface defining an interior volume;
a drumhead stretched over the first end of the shell; and
at least one resonator coupled at one edge in lever fashion to the interior surface of the shell, the at least one resonator being sized and shaped to resonate at a frequency proximate to a peak resonant frequency of the drum and/or another frequency on a resonant curve of the drum.

2. The acoustic drum, of claim 1, wherein:
the at least one resonator is substantially planar and includes first and second opposing surfaces; and
the first and second surfaces are substantially parallel with the drumhead.

3. The acoustic drum, of claim 1, wherein the at least one resonator is located approximately half-way between the first and second ends of the shell.

4. The acoustic drum, of claim 1, wherein the at least one resonator is substantially planar and includes a surface area of sufficient magnitude to: (i) receive acoustic energy from the drumhead, when struck, and the shell; and (ii) move a sufficient amount of air, and increase a magnitude of the acoustic energy within, the shell at the peak resonant frequency.

5. The acoustic drum, of claim 1, wherein the one edge of the at least one resonator includes a length, and no more than about 20% of the length of the edge is rigidly coupled to the shell.

6. The acoustic drum, of claim 1, further comprising a connecting means operable to rigidly couple the one edge of the at least one resonator to the interior surface of the shell such that the one edge of the resonator is spaced away from the interior surface.

7. The acoustic drum, of claim 6, wherein the one edge of the at least one resonator includes a length, and the spacing between the interior surface of the shell and the one edge of the resonator is about 10% of the length of the edge.

8. The acoustic drum, of claim 1, wherein the at least one resonator includes an opposite edge to the one edge thereof, the opposite edge having a notch therein.

9. An acoustic drum, comprising:
a shell having first and second, spaced apart ends, and an interior surface defining an interior volume;
a drumhead stretched over the first end of the shell; and
a plurality of resonators, each coupled at one edge thereof in lever fashion to the interior surface of the shell, and each resonator being sized and shaped to resonate at a frequency proximate to a peak resonant frequency of the drum.

10. The acoustic drum, of claim 9, wherein the resonators are disposed in co-planar relationship to one another.

11. The acoustic drum, of claim 9, wherein:
the interior surface of the shell defines a substantially circular cross section; and
the resonators are disposed radially about a circumference of the interior surface of the shell.

12. The acoustic drum, of claim 9, wherein the resonators are circumferentially spaced apart from one another to permit air to flow therebetween.

13. The acoustic drum, of claim 9, wherein:
each of the resonators includes an opposite edge to the one edge thereof; and
the opposite edge of each resonator is concave curvilinear.

14. The acoustic drum, of claim 13, wherein the concave curvilinear opposite edges of the resonators define a central aperture through which an acoustic air column may pass.

15. The acoustic drum, of claim 9, wherein the resonators are substantially planar.

16. The acoustic drum, of claim 9, wherein the resonators include first and second opposing surfaces that are substantially parallel with the drumhead.

17. The acoustic drum, of claim 13, wherein:
a cross-sectional area of the interior volume at which the resonators are located defines an acoustic air flow passage area;
a total amount of the acoustic air flow passage area interrupted by the resonators is no more than about 40%-50% thereof.

18. The acoustic drum, of claim 9, wherein the resonators are located approximately half-way between the first and second ends of the shell.

19. The acoustic drum, of claim 9, wherein each of the resonators are substantially planar and include a surface area of sufficient magnitude to: (i) receive acoustic energy from the drumhead, when struck, and the shell; and (ii) move a sufficient amount of air, and increase a magnitude of the acoustic energy within, the shell at the peak resonant frequency.
